(19) United States
(12) Patent Application Publication
(10) Pub. No.: US 2026/0061739 A1
(43) Pub. Date: Mar. 5, 2026

(54) HEAT-PRESSING MACHINE

(71) Applicant: Silhouette Japan Corporation, Kanagawa (JP)

(72) Inventor: Masaki SUGIYAMA, Kanagawa (JP)

(21) Appl. No.: 19/283,523

(22) Filed: Jul. 29, 2025

(30) Foreign Application Priority Data
Aug. 28, 2024 (JP) 2024-146676

(51) Int. Cl. B41F 16/00; B41F 16/02

(52) U.S. Cl. CPC B41F 16/0026; B41F 16/0093; B41F 16/02

(57) ABSTRACT

To provide a heat-pressing machine capable of appropriately performing a thermal transfer process. A heat-pressing machine includes: a base member on which a transfer object and a thermal transfer sheet are placed, a rotating member that is attached to the base member via a rotating shaft, and a pressing member that rotates together with the rotating member to press the base member. The base member includes a base body and a placement plate movably attached to the base body. The pressing member includes a pressing body movably attached to the rotating member, and a heater unit. When the rotating member rotates relative to the base member, the pressing member presses the base member while the heater unit faces the placement plate. The placement plate and the pressing body are movable so that a placement surface of the placement plate and a heater surface of the heater unit are aligned.

This application claims priority from Japanese Patent Application Serial Number JP 2024-146676, filed Aug. 28, 2024, the entire contents of which are hereby incorporated by reference into this application.

### BACKGROUND OF THE INVENTION

### Field of the Invention

The present invention relates to a heat-pressing machine and particularly to a heat-pressing machine for heating a thermal transfer sheet while being pressed against a transfer object.

### Description of the Related Art

Conventionally, there has been known a heat-pressing machine capable of performing a thermal transfer process by heating a thermal transfer sheet while being pressed against a transfer object such as clothing.

A thermal transfer sheet (iron print) is a sheet in which a heat-meltable adhesive (for example, a hot melt adhesive) is applied to a back side of a printed layer with a predetermined pattern or design. By melting the adhesive in a predetermined temperature environment and applying a predetermined pressure thereto, the adhesive permeates the transfer object, and the thermal transfer sheet (printed layer) can be integrated with the transfer object.

Among the heat-pressing machines, there are large heat-pressing machines as described in JP 2023-166097 A and JP H07-276897 A as well as small, portable, and compact type heat-pressing machines.

The heat-pressing machine described in JP 2023-166097 A includes a lower iron (base member) on which a fabric is placed and an upper iron (pressing member) which is provided to sandwich a fabric and a thermal transfer sheet between the lower iron and the upper iron and performs a thermal transfer process on the fabric. Then, the upper iron is rotatably attached via a link mechanism to a pillar fixed to the rear end of the lower iron.

The heat-pressing machine described in JP H07-276897 A also has the same configuration, and a heating iron (pressing member) is attached to a device base via a link device and a compression spring to be rotatable and have a resilient effect.

Incidentally, in the heat-pressing machine, particularly a small heat-pressing machine, when a pressing member rotates to press the base member, the pressing operation may be performed while a pressing surface of the pressing member and a placement surface of a placement portion are not aligned. That is, the pressing member may not uniformly press the base member. Therefore, the finishing of the thermal transfer process is affected.

In the heat-pressing machine described above, since the pressing member rotates relative to the base member via a link mechanism, the pressing surface of the pressing member can be adjusted to be slightly inclined, but there is still a risk that the pressing surface of the pressing member and the placement surface of the placement portion are not aligned. Furthermore, in a large heat-pressing machine, it is assumed that a generally uniform pressure (vertical pressure) can be applied even when the pressing surface of the pressing member and the placement surface of the placement portion do not match to some extent.

An object of the present invention is to provide a heat-pressing machine capable of performing a thermal transfer process more appropriately than ever before.

Further, another object of the present invention is to provide a heat-pressing machine capable of performing a heat-pressing operation with a uniform pressure.

Further, still another object of the present invention is to provide a heat-pressing machine capable of performing a heat-pressing operation with a uniform pressure even when the heat-pressing machine is made small and lightweight.

### SUMMARY OF THE INVENTION

According to a heat-pressing machine of the present invention, the above-described problems are solved by a heat-pressing machine for heating a thermal transfer sheet while being pressed against a transfer object, including: a base member on which the transfer object is placed; a rotating member that is attached to the base member via a rotating shaft and rotates around the rotating shaft relative to the base member; and a pressing member that is attached to the rotating member, disposed to sandwich the transfer object and the thermal transfer sheet between the pressing member and the base member, and is adapted to rotate together with the rotating member to press the base member, wherein the base member includes a base body which serves as a main body of the base member and a placement portion which is provided in the base body, movably attached to the base body, and adapted to place the transfer object thereon, wherein the pressing member includes a pressing body which is movably attached to the rotating member and a heater unit which is provided in the pressing body and is able to generate heat, wherein when the rotating member rotates relative to the base member, the pressing member presses the base member while the heater unit faces the placement portion, and wherein each of the placement portion and the pressing body is movable so that a placement surface of the placement portion and a heater surface of the heater unit are aligned.

With the above-described configuration, it is possible to realize the heat-pressing machine capable of performing a heat-pressing operation with a uniform pressure and appropriately performing a thermal transfer process.

Specifically, the base member includes the base body and the placement portion movably attached to the base body. The pressing member includes the pressing body movably attached to the rotating member and the heater unit provided in the pressing body. Accordingly, when the rotating member rotates relative to the base member, the pressing member presses the base member while the heater unit faces the placement portion. Then, each of the placement portion and the pressing body is movable so that the placement surface of the placement portion and the heater surface of the heater unit are aligned. As a result, a heat-pressing operation can be performed with a uniform pressure.

At this time, the rotating shaft may extend in a left and right direction of the heat-pressing machine and connect a rear end of the base member to a lower end of the rotating member, the pressing member may be attached to the rotating member via a connecting shaft and swing around the connecting shaft relative to the rotating member, the connecting shaft may extend in an extending direction of the rotating shaft or a direction intersecting the extending direction of the rotating shaft, when the rotating member rotates relative to the base member, the pressing body may swing around the connecting shaft so that the placement surface and the heater surface are aligned, and the placement portion may be movable in accordance with a swinging operation of the pressing body.

With the above-described configuration, the pressing body can swing around the connecting shaft so that the placement surface and the heater surface are aligned. Accordingly, the placement surface of the placement portion and the heater surface of the heater unit can be easily aligned during a heat-pressing operation.

At this time, the placement portion may swing around a support shaft relative to the base body, each of the connecting shaft and the support shaft may extend in the extending direction of the rotating shaft, and when the rotating member rotates relative to the base member, the placement portion and the pressing body may swing so that the placement surface and the heater surface are aligned.

With the above-described configuration, the placement portion and the pressing body can swing so that the placement surface and the heater surface are aligned. Accordingly, the placement surface of the placement portion and the heater surface of the heater unit can be more easily aligned during a pressing operation.

At this time, the heat-pressing machine may further include: a locking device which locks a rotating operation of the rotating member relative to the base member, the rotating member may rotate to be switched between a normal position in which the rotating member stands upward relative to the base member and a press position in which the pressing member is in contact with the base member, and the locking device may be provided in a connecting portion between the base member and the rotating member and lock the rotating member at the normal position.

With the above-described configuration, since the unintentional rotation can be prevented when the rotating member is located at the “normal position”, it is possible to realize the heat-pressing machine having improved safety.

For example, when the pressing member falls unintentionally while placing the transfer object on the placement table, a user may be burned. Therefore, safety can be further improved by providing the above-described locking device.

At this time, the locking device may include a locking member that is attached to one of the base member and the rotating member and switched between a locked position and an unlocked position, a locked portion which is provided in the other of the base member and the rotating member and engages with the locking member when the locking member is at the locked position, a biasing member that biases the locking member from the unlocked position toward the locked position, and an operation member that is connected to the locking member and switches the position of the locking member against a biasing force of the biasing member, and the operation member may be disposed to be exposed on an outer surface of the heat-pressing machine in the left and right direction and operable toward the inside or outside of the heat-pressing machine in the left and right direction.

With the above-described configuration, the locking device can be mounted with a simple configuration.

Further, as described above, the operation member is exposed on the outer surface of the heat-pressing machine in the left and right direction, and is operable toward the inside or outside of the heat-pressing machine in the left and right direction. Therefore, the user can hold the rotating member with one hand and operate the operating member with the other hand.

At this time, the locking member may be switched between the locked position and the unlocked position by moving in the left and right direction of the heat-pressing machine, when the rotating member is located at the normal position, the locking member may be movable to the locked position and be engaged with the locked portion in an up and down direction or a front and rear direction at the locked position, and when the rotating member is located at the press position, the locking member may not be movable to the locked position, be located on the outside or inside of the locked portion in the left and right direction of the heat-pressing machine, and not be engaged with the locked portion.

With the above-described configuration, it is possible to realize a configuration in which the rotating member can be locked when the rotating member is located at the “normal position” and the rotating member cannot be locked when the rotating member is located at the “press position” by a simple structure. That is, it is possible to realize the heat-pressing machine which is easily operated by the user and has improved safety.

At this time, the heat-pressing machine may further include: a heat-pressing body which serves as a main body of the heat-pressing machine; and a heating tool which is used after a thermal transfer process by the heat-pressing body and has a heating portion capable of generating heat, the heating tool may be adapted to be switchable between a normal position in which the heating portion is stored inside the heating tool and a use position in which the heating portion is exposed to the outside, a storage recess capable of removably storing the heating tool may be formed at a predetermined position of the heat-pressing body, and the heating tool may be storable in the storage recess in the state of the normal position and be removable from the storage recess in the state of the normal position.

With the above-described configuration, the heating tool can be used as an auxiliary tool after the thermal transfer process by the heat-pressing body. That is, if minute uneven portions (bumps) occur at the corners or edges when the thermal transfer sheet is attached to the transfer object, they can be finished using the heating tool.

Further, as described above, the heating tool can be removably stored in the storage recess of the heat-pressing body. Accordingly, the heating tool can be compactly mounted.

According to the heat-pressing machine of the present invention, the thermal transfer process can be performed more appropriately than ever before. Further, a heat-pressing operation can be performed with a uniform pressure.

Further, even when the heat-pressing machine is made small and lightweight, a heat-pressing operation can be performed with a uniform pressure.

### BRIEF DESCRIPTION OF THE DRAWINGS

FIG. 1 is a perspective view of a heat-pressing machine and is a diagram showing a “normal position”.

FIG. 2 is a perspective view of a heat-pressing machine and is a diagram showing a “press position”.

FIG. 3 is a main enlarged view of FIG. 1 and is a diagram showing a base member.

FIG. 4 is a main enlarged view of FIG. 1 and is a diagram showing a rotating member and a pressing member.

FIG. 5 is a side view of the rotating member and the pressing member.

FIG. 6 is a side view of a base member and a pressing member and is a diagram showing a “press position”.

FIG. 7 is a perspective view of a locking device and is a diagram showing a “locked position”.

FIG. 8 is a perspective view of a locking device and is a diagram showing an “unlocked position”.

FIG. 9 is a front view of a locking device and is a diagram showing an “unlocked position”.

FIG. 10 is a side view of a locking device and is a diagram showing an “unlocked position”.

FIG. 11 is a block n showing a hardware configuration and a function of a heat-pressing machine.

FIG. 12 is a bottom view of a heat-pressing machine and is a diagram showing a state in which a heating tool is stored.

### DESCRIPTION OF THE PREFERRED EMBODIMENTS

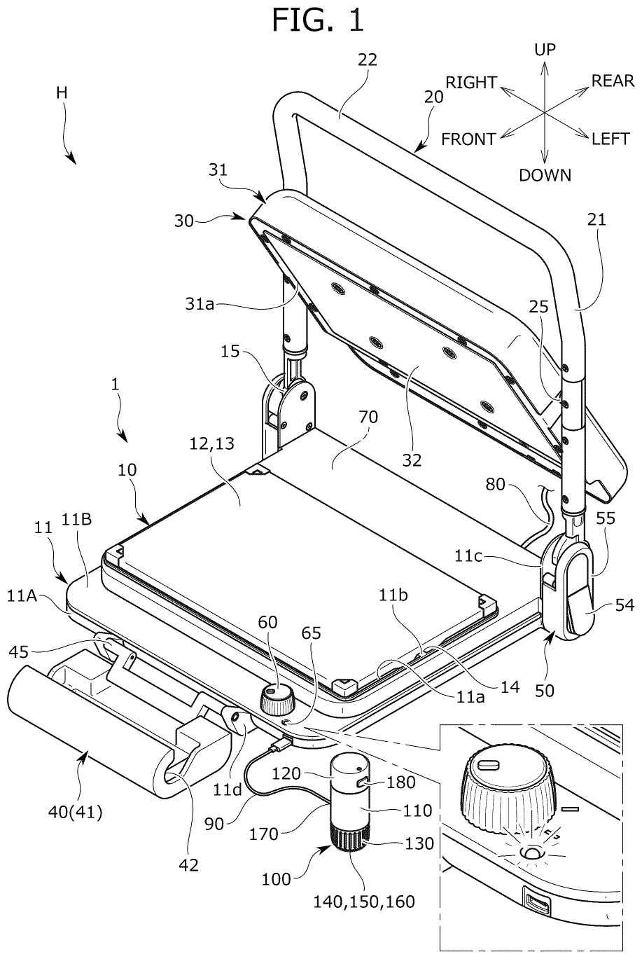

Hereinafter, embodiments of the present invention will be described with reference to FIGS. 1 to 12.

This embodiment relates to a “heat-pressing machine” that is used when heating a thermal transfer sheet while being pressed against a transfer object and moves each of a base member and a pressing member to enable heat-pressing with a uniform pressure.

### <Entire Configuration>

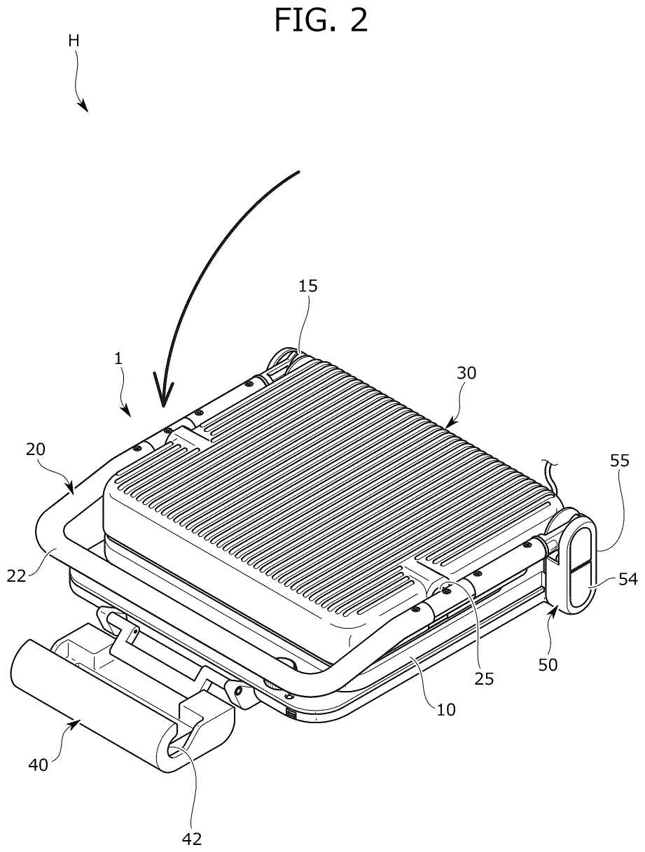

A heat-pressing machine H is, as shown in FIGS. 1 and 2, a portable and compact heat-pressing machine, and receives a user's operation input and performs desired thermal transfer by heating a thermal transfer sheet while being pressed against a transfer object in a preset temperature environment.

The heat-pressing machine H includes a heat-pressing body 1 which is a main body of the heat-pressing machine H and a heating tool 100 which is used after a thermal transfer process using the heat-pressing body 1 to perform desired thermal transfer.

Furthermore, the heat-pressing machine H may be a large heat-pressing machine. Further, the heat-pressing machine H may not include the heating tool 100.

The “transfer object” is a base material onto which a thermal transfer sheet is transferred, and specifically includes textile products such as clothing. Furthermore, the present invention is not particularly limited to textile products, and can be applied to a wide range of base materials that can be thermally transferred.

The “thermal transfer sheet” is a sheet in which a heat-meltable adhesive layer is formed on a back side of a printed layer. Specifically, the sheet is cut into a desired shape using a cutting plotter or the like before the thermal transfer process. Furthermore, the sheet is not particularly limited as long as thermal transfer can be performed.

The heat-pressing body 1 includes, as shown in FIGS. 1 to 6, a base member 10 on which the transfer object and the thermal transfer sheet are placed, a rotating member 20 that is attached to the base member 10 via a rotating shaft 15, and a pressing member 30 that is attached to the rotating member 20, disposed to sandwich the transfer object and the thermal transfer sheet between the pressing member and the base member 10, and adapted to rotate together with the rotating member 20 to press the base member.

Further, the heat-pressing body 1 includes a handle 40 which is attached to the front end of the base member 10 via a handle shaft 45 and a locking device 50 which is attached to the rear end of the base member 10 and locks the rotating operation of the rotating member 20 relative to the base member 10.

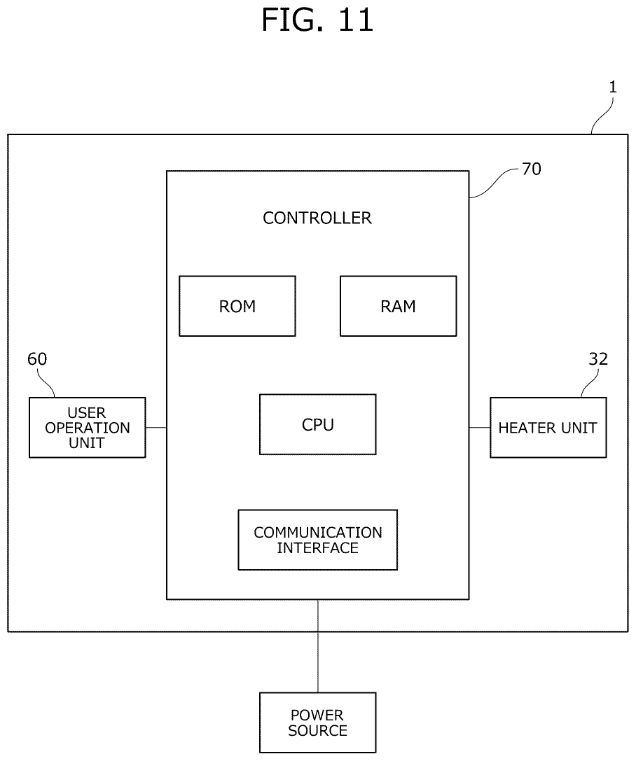

Further, the heat-pressing body 1 includes, as shown in FIGS. 1 and 11, a user operation unit 60 which receives a user's operation input, a lamp 65 which lights up when electricity is supplied to the heat-pressing body 1, and a controller 70 which is provided inside the heat-pressing body 1 and performs various calculations and controls.

In addition, a power cord 80 is connected to the rear end of the base member 10, and an electric cable 90 is connected to the front end of the base member 10.

Furthermore, the heat-pressing body 1 may further include a user display unit for displaying the contents of various settings and messages.

### <Base Member (Placement Table)>

The base member 10 is, as shown in FIGS. 1 to 6, a member that serves as a placement table (press table) of the heat-pressing body 1, and includes a base body 11 which serves as a main body of the base member 10, a placement plate 12 which is attached to the upper surface (surface) of the base body 11 to place the transfer object and the thermal transfer sheet thereon, and a heat-resistant placement mat 13 which is attached to the surface of the placement plate 12.

The placement plate 12 and the placement mat 13 correspond to the “placement portion”.

The placement plate 12 (placement mat 13) is adapted to be swingable (to sway) relative to the base body 11 around a support shaft 14.

The base body 11 is formed by stacking a plurality of plates in the vertical direction, and includes a first base member 11A having a plate shape and a second base member 11B having a plate shape and fixed to the upper surface of the first base member 11A.

For example, electric wires (not shown) and a harness made up of bundled electric wires extend through the space between the first base member 11A and the second base member 11B.

A rectangular plate storage portion 11a (plate storage recess) for storing the placement plate 12 is formed at the center of the base body 11. A shaft support portion 11b for supporting the support shaft 14 is formed on both left and right ends of the plate storage portion 11a.

Connection brackets 11c for connecting the rotating shaft 15 and the locking device 50 are attached on the left and right sides of the rear end of the base body 11.

Handle attachment portions 11d for attaching the handle 40 (handle shaft 45) are formed at the front end of the base body 11 with a space between them on the left and right sides.

Further, the upper surface of the front end of the base body 11 is provided with an attachment hole for attaching the user operation unit 60 (operation dial) and an opening hole for exposing the lamp 65.

In addition, a cord connection portion is formed on the rear end surface of the base body 11, and a cable connection portion is formed on the front end surface of the base body 11.

The placement plate 12 is a member that is swingable relative to the base body 11 around the support shaft 14 extending in the left and right direction of the heat-pressing body 1.

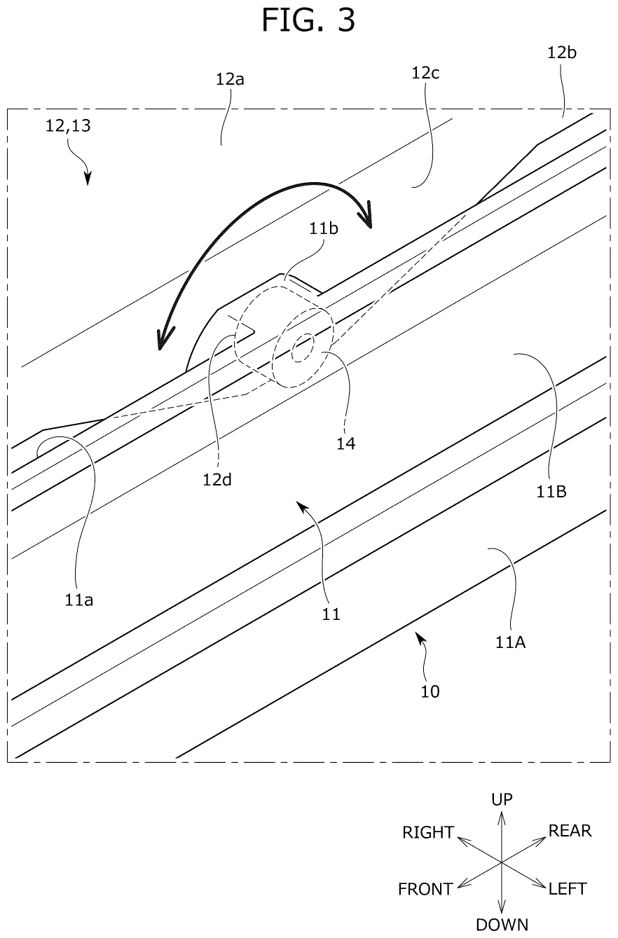

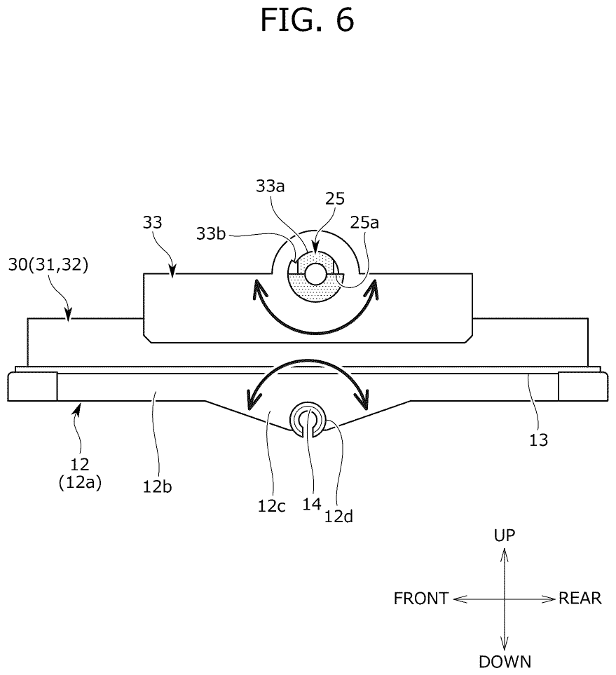

Specifically, as shown in FIGS. 3 and 6, the placement plate 12 swings so that the front portion of the placement plate 12 is inclined to a predetermined angle (for example, 15 to 30°) relative to the base body 11, and swings so that the rear portion of the placement plate 12 is inclined to a predetermined angle (for example, 15 to 30°) relative to the base body 11.

Furthermore, the inclination angle of the placement plate 12 can be set appropriately.

The placement plate 12 includes, as shown in FIGS. 3 and 6, a rectangular plate body 12a and an outer peripheral flange 12b protruding downward from the outer peripheral portion of the plate body 12a over substantially the entire length.

Further, both ends of the placement plate 12 in the left and right direction are provided with a center flange 12c which protrudes downward further than the outer peripheral flange 12b. A shaft support portion 12d (shaft support groove) that axially supports the support shaft 14 is formed at the protruding end of the center flange 12c.

Furthermore, the support shaft 14 is axially supported by the base body 11 (shaft support portion 11b) and the placement plate 12 (shaft support portion 12d).

The placement plate 12 is stored in the plate storage portion 11a, and a gap (space) is formed between the placement plate 12 and the base body 11 in the up and down direction. In other words, the placement plate 12 is supported by the support shaft 14 while the plate body 12a is slightly raised from the base body 11.

Accordingly, the placement plate 12 is swingable around the support shaft 14 relative to the base body 11 in the up and down direction.

Furthermore, the placement plate 12 is normally placed in a horizontal state (approximately horizontal state) due to gravity.

The placement mat 13 is a resin mat made of, for example, silicone resin or fluororesin, and is fixed to the upper surface of the placement plate 12.

The placement mat 13 is disposed at a position facing a heater unit 32 provided on the bottom surface of the pressing member 30 (pressing body 31).

### <Rotating Member (Rotating Frame)>

The rotating member 20 is, as shown in FIGS. 1 to 5, a rotating frame which rotates around the rotating shaft 15 relative to the base member 10.

Specifically, the rotating member 20 rotates to be switched between a “normal position” in which the rotating member stands upward relative to the base member 10 and a “press position” in which the pressing member 30 is in contact with the base member 10.

The rotating member 20 includes left and right side frames 21 which extend upward from the left and right side portions of the rear end of the base member 10 and a connecting frame 22 which connects the upper ends of the left and right side frames 21.

The left and right side frames 21 support the pressing member 30 to sandwich the pressing member therebetween.

The connecting frame 22 functions as a grip portion that can be held by a user. For example, the user can rotate the rotating member 20 by gripping the connecting frame 22 with one hand (left hand) and operating the operation member 54 of the locking device 50 with the other hand (right hand).

The rotating shaft 15 which extends in the left and right direction of the heat-pressing body 1 is axially supported by the lower end of the side frame 21.

Further, a connecting shaft 25 which extends toward the inside of the side frame 21 is axially supported by the center portion of the side frame 21 in the up and down direction. Specifically, the connecting shaft 25 is integrally fixed to the inner surface of the side frame 21.

Furthermore, the rotating member 20 and the connecting shaft 25 each have a pipe shape (a cylindrical shape), and a harness (not shown) extends inside the right rotating member 20 and the connecting shaft 25. The harness extends from the base member 10 (cord connection portion) to the pressing member 30 (heater unit 32) and supplies electricity to the heater unit 32.

### <Pressing Member (Heat-Pressing Member)>

The pressing member 30 is, as shown in FIGS. 1 to 6, a member that serves as a heat-pressing plate of the heat-pressing body 1, disposed inside the frame-shaped rotating member 20, and adapted to rotate together with the rotating member 20.

Specifically, the pressing member 30 rotates together with the rotating member 20, and presses the base member 10 while the heater unit 32 faces the placement plate 12. Then, the connecting shaft 25 is adapted to be swingable relative to the rotating member 20.

The pressing member 30 includes a pressing body 31 which is swingably attached to the rotating member 20 and a heater unit 32 which is provided on the back surface (bottom surface) of the pressing body 31 and is able to generate heat.

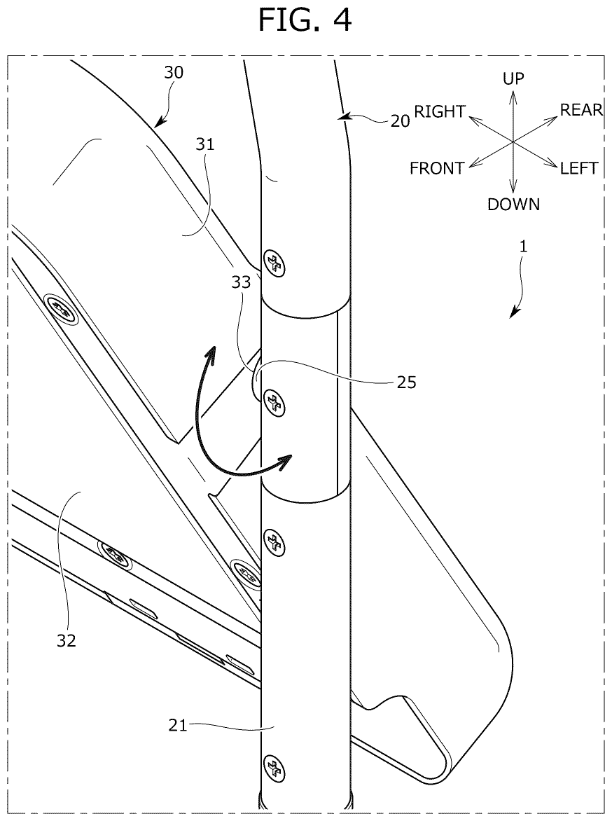

As shown in FIGS. 4 to 6, a shaft support bracket 33 which axially supports the connecting shaft 25 is attached to the outer surface of the pressing body 31 in the left and right direction.

The pressing body 31 has a three-dimensional shape and is disposed to be surrounded by the rotating member 20.

The bottom surface of the pressing body 31 is provided with a rectangular heater storage portion 31a (heater storage recess) for storing the heater unit 32.

The heater unit 32 is a rectangular plate-shaped member capable of generating heat, and is made of a metal with high thermal conductivity.

The heater unit 32 is connected to the user operation unit 60 (operation dial) via an electric wire (harness) (not shown). The heating temperature of the heater unit can be adjusted by the user operation unit 60.

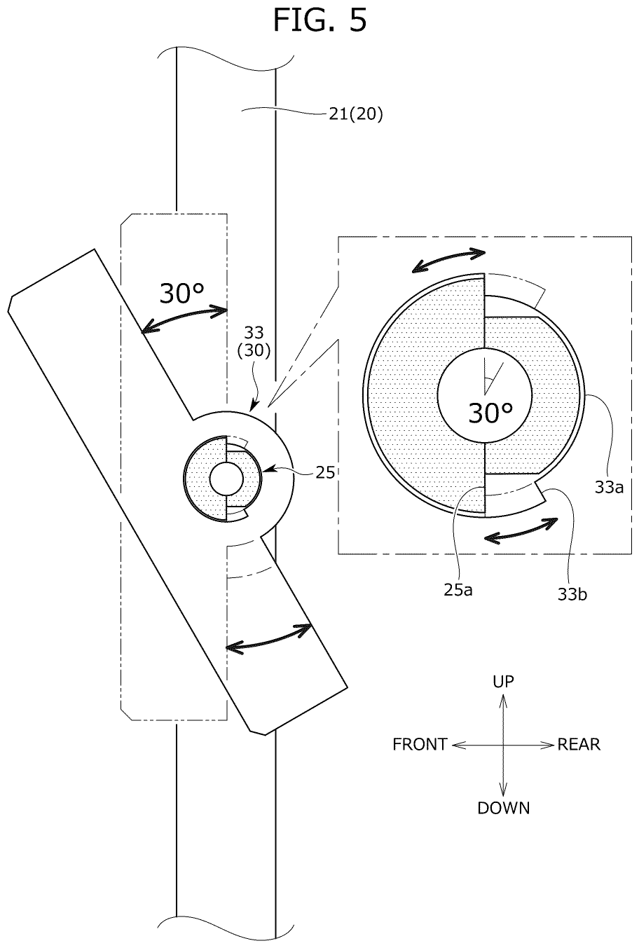

The shaft support bracket 33 includes, as shown in FIGS. 4 and 5, a shaft support hole 33a which penetrates the heat-pressing body 1 in the left and right direction and supports the connecting shaft 25.

The connecting shaft 25 is axially supported by the rotating member 20 (connecting frame 22) and the pressing member 30 (shaft support bracket 33).

Specifically, a convex restricting protrusion 25a is formed on the outer peripheral surface of the connecting shaft 25. Then, a concave (groove-shaped) restricting recess 33b (restricting groove) which can engage with the restricting protrusion 25a is formed on the edge portion of the shaft support hole 33a in the shaft support bracket 33.

The restricting recess 33b extends along the edge portion of the shaft support hole 33a, and the restricting protrusion 25a is movable within the area provided with the restricting recess 33b.

The restricting protrusion 25a comes into contact with the circumferential edge portion of the shaft support hole 33a in the restricting recess 33b, so that the movement of the pressing member 30 relative to the rotating member 20 is restricted.

With the above-described configuration, as shown in FIGS. 4 to 6, the pressing member 30 can swing around the connecting shaft 25 relative to the rotating member 20 to be inclined to a predetermined angle. That is, when the pressing member 30 is inclined to a predetermined angle relative to the rotating member 20, the movement of the pressing member 30 is restricted.

Specifically, the pressing member 30 swings so that the upper portion is inclined back and forth to a predetermined angle (for example, 15° to 30°) relative to the rotating member 20 and the rear portion is inclined back and forth to a predetermined angle (for example, 15° to 30°) relative to the rotating member 20.

The inclination angle of the pressing member 30 can be appropriately set.

Furthermore, the pressing member 30 is placed in a horizontal state (approximately horizontal state) due to gravity during the heat-pressing operation shown in FIGS. 2 and 6.

In the above-described configuration, as shown in FIGS. 2 and 6, when the rotating member 20 rotates relative to the base member 10, the pressing member 30 presses the base member 10 while the heater unit 32 faces the placement plate 12. Then, the placement plate 12 and the pressing body 31 respectively swing so that the placement surface of the placement plate 12 and the heater surface of the heater unit 32 are aligned.

Specifically, the pressing body 31 swings around the connecting shaft 25 so that the placement surface and the heater surface are aligned. Then, the placement plate 12 swings in accordance with the swinging operation of the pressing body 31.

Accordingly, the heat-pressing body 1 can perform a heat-pressing operation with a more uniform pressure.

In the above-described configuration, as shown in FIGS. 2 and 6, when the heat-pressing body 1 (rotating member 20) is located at the “press position”, the support shaft 14 and the connecting shaft 25 are arranged at an aligned position in the up and down direction (facing positions in the up and down directions) in the side view of the heat-pressing body 1. In other words, the support shaft 14 and the connecting shaft 25 are arranged at the same position in the front and rear direction of the heat-pressing body 1.

Accordingly, when the placement plate 12 and the pressing member 30 swing, the placement surface of the placement plate 12 and the heater surface of the heater unit 32 can be aligned with higher accuracy. As a result, since the heat-pressing body 1 can perform a heat-pressing operation with a uniform pressure, the finishing of the thermal transfer process can be made better.

### <Handle (Handle Portion)>

As shown in FIGS. 1 and 2, the handle 40 is a portion that the user holds when carrying the heat-pressing machine H, and is attached to the front end of the base member 10.

The handle 40 is rotatably attached to the base member 10 via the handle shaft 45, and also has a function of being hooked to the rotating member 20 when the heat-pressing body 1 is folded (the heat-pressing body 1 is located at the “press position”).

The handle 40 is rotatably attached to the base member 10 and includes a handle body 41 which serves as a portion held by the user and a hook portion 42 which is formed at the tip of the handle body 41 and can be hooked to the rotating member 20 (connecting frame 22).

With the above-described configuration, the user can conveniently pick up and carry the heat-pressing machine H in the folded state.

### <Locking Device>

The locking device 50 is, as shown in FIGS. 1 and 7 to 10, a device that locks the rotating operation of the rotating member 20 relative to the base member 10 and connects the rear end of the base member 10 to the lower end of the rotating member 20.

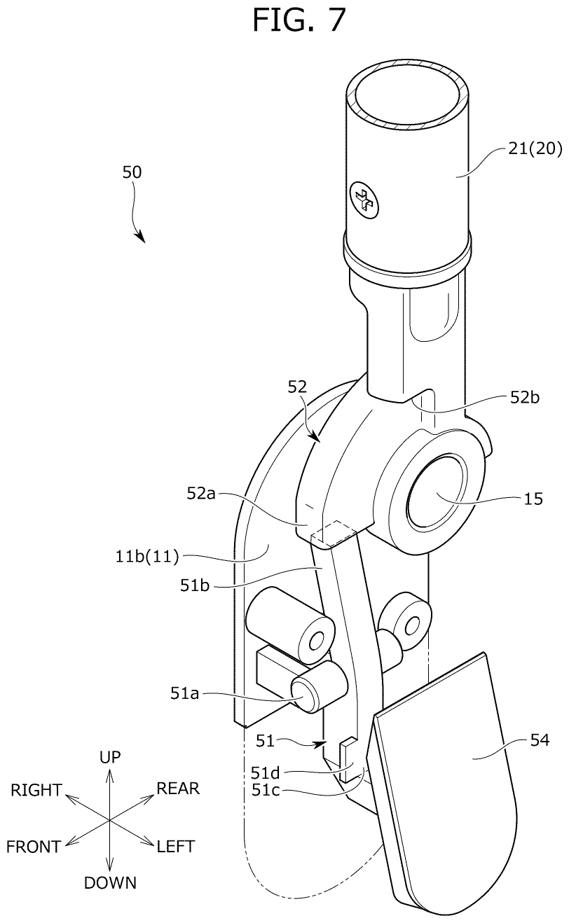

The locking device 50 can lock the rotating member 20 when the rotating member 20 is located at the “normal position” as shown in FIG. 7.

The locking device 50 includes a locking member 51 that is attached to the outer surface of the base member 10 (shaft support portion 11b), a locked portion 52 which is provided at the lower end of the rotating member 20 and engages with the locking member 51, a biasing spring 53 which is attached to the locking member 51 and biases the locking member 51 to a predetermined position, and an operation member 54 that is connected to the locking member and switches the position of the locking member against the biasing force of the biasing spring 53.

Further, the locking device 50 includes a lock cover 55 which is attached to the outer surface of the base member 10 (shaft support portion 11b) and covers the locking member 51, the locked portion 52, and the biasing spring 53 from the outside.

An opening corresponding to the operation member 54 is formed on the outer surface of the lock cover 55, and the lock cover 55 is attached to the shaft support portion 11b while the operation member 54 is exposed.

As shown in FIGS. 1 and 7 to 9, the locking member 51 is disposed to be sandwiched between the shaft support portion 11b and the lock cover 55 and is supported by the shaft support portion 11b and the lock cover 55.

The locking member 51 includes a locking shaft 51a which extends along the front and rear direction of the heat-pressing body 1 and serves as a rotation center of the locking member 51, an engagement portion 51b which extends upward from the locking shaft 51a and engages with the locked portion 52, a contact portion 51c which extends downward from the locking shaft 51a and comes into contact with the operation member 54, and a hook portion 51d which is provided at the lower end of the contact portion 51c and hooks the free end of the biasing spring 53.

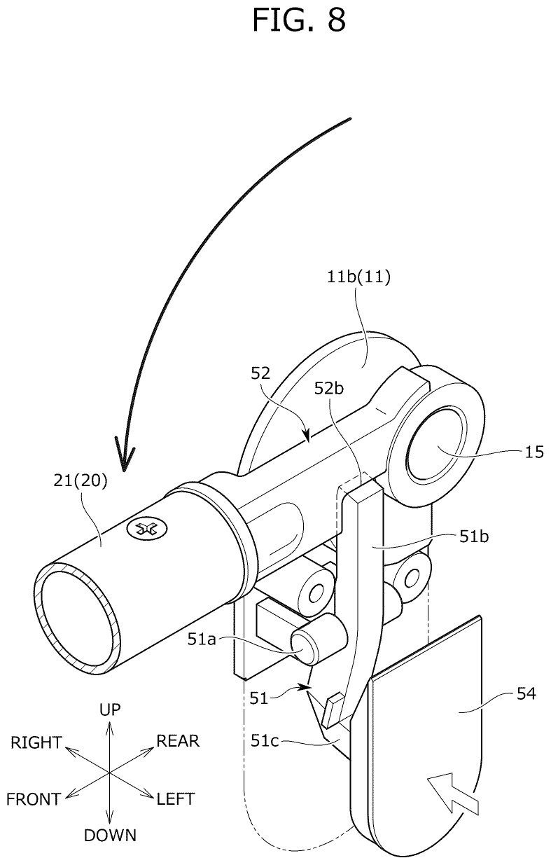

the locking member 51 rotates in the left and right direction of the heat-pressing body 1 around the locking shaft 51a to be switched between a “locked position” shown in FIG. 7 and an “unlocked position” shown in FIG. 8.

Specifically, the operation member 54 is provided to be exposed on the outer surface of the heat-pressing body 1 in the left and right direction, and protrudes outward from the lock cover 55. The user can operate the operation member 54 to be retracted into the heat-pressing body 1.

When the user pushes the operation member 54, the operation member 54 comes into contact with the contact portion 51c so that the contact portion 51c is pressed into the heat-pressing body 1.

Accordingly, the locking member 51 rotates around the locking shaft 51a so that the engagement portion 51b moves toward the outside of the heat-pressing body 1.

That is, the locking member 51 is switched from the “locked position” to the “unlocked position”.

The locked portion 52 includes, as shown in FIGS. 7 to 10, an engagement portion 52a which engages with the locking member 51 when the rotating member 20 is located at the “normal position position)” (upright and a movement restricting portion 52b which comes into contact with the locking member 51 when the rotating member 20 is located at the “press position (laid position)”.

When the engagement portion 52a of the locked portion 52 engages with the locking member 51 (engagement portion 51b), the locking device 50 locks the rotating member 20 at the “normal position”.

On the other hand, when the movement restricting portion 52b comes into contact with the locking member 51, the locking device 50 unlocks the rotating member 20. That is, the rotating member 20 is freely rotatable.

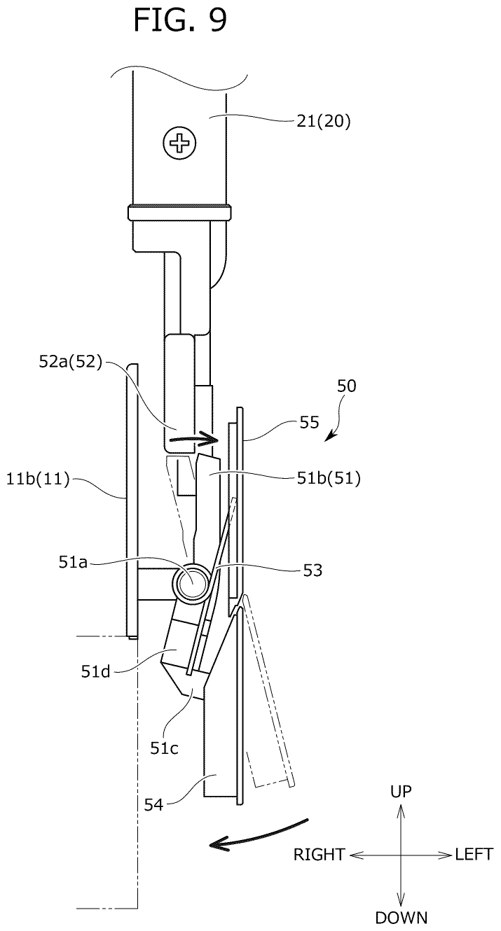

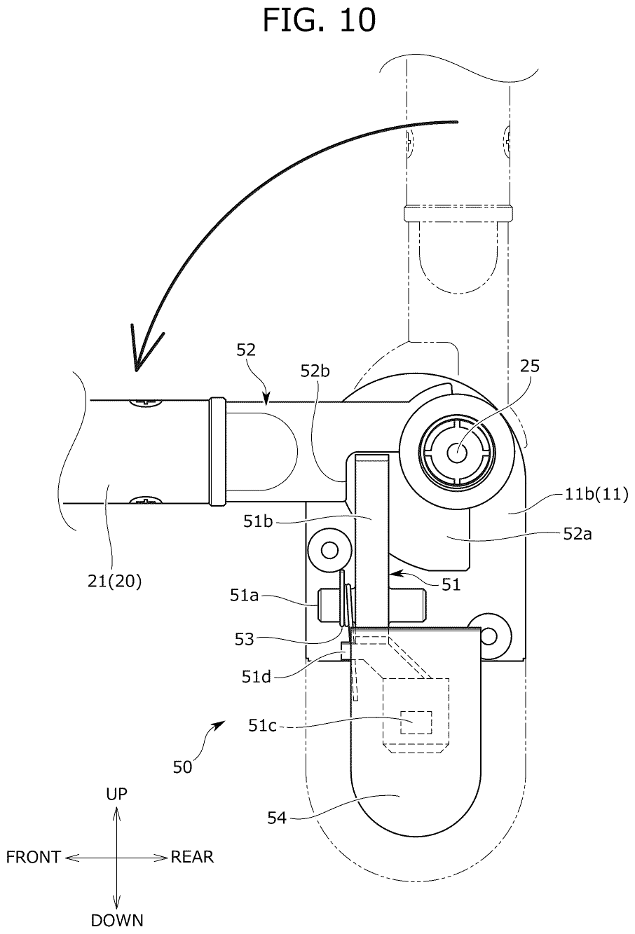

The biasing spring 53 is, as shown in FIGS. 9 and 10, a biasing member that biases the locking member 51 from the unlocked position toward the locked position.

When the rotating member 20 is located at the “normal position (upright position)” shown in FIG. 7, the biasing spring 53 biases the locking member 51 toward the “locked position”, and the engagement between the locking member 51 and the locked portion 52 (engagement portion 52a) is maintained.

On the other hand, when the rotating member 20 is located at the “press position” shown in FIG. 8, the biasing spring 53 biases the locking member 51 toward the locked position, and the contact between the locking member 51 and the locked portion 52 (movement restricting portion 52b) is maintained. In other words, since the locking member 51 first comes into contact with the movement restricting portion 52b, the biasing spring 53 cannot bias the locking member 51 to the locked position.

In the above-described configuration, when the rotating member 20 is located at the “normal position (upright position)” shown in FIG. 7, the locking member 51 is movable to the “locked position” and engages with the locked portion 52 (engagement portion 52a) at the “locked position” in the up and down direction. That is, the locking member 51 locks the rotating member 20.

On the other hand, when the rotating member 20 is located at the “press position (laid position)” shown in FIG. 8, the locking member 51 is not movable to the “locked position” and is located outside the locked portion 52 (engagement portion 52a) in the left and right direction of the heat-pressing machine H not to engage with the locked portion 52. That is, the locking member 51 is in contact with the movement restricting portion 52b of the locked portion 52. Accordingly, the locking member 51 cannot lock the rotating member 20 and unlocks the rotating member.

With the above-described configuration, it is possible to realize a configuration in which the rotating member 20 can be locked when the rotating member 20 is located at the “normal position” and the rotating member 20 cannot be locked when the rotating member 20 is located at the “press position” by a simple structure. That is, it is possible to realize the heat-pressing machine H which is easily operated by the user and has improved safety.

### <User Operation Unit, Controller>

The user operation unit 60, as shown in FIGS. 1 and 11, is for receiving a user's operation input for operating the thermal transfer process, and is attached to the upper surface of the base member 10.

The user operation unit 60 is, for example, an operation dial and can set the heating temperature of the heater unit 32. Specifically, the user operation unit can be switched between an “Off mode” which does not generate heat, a “Low mode” which sets the heating temperature to 120° C., a “Medium mode” which sets the heating temperature to 160° C., and a “High mode” which sets the heating temperature to 200° C.

When pressing (heat pressing) is performed with the user operation unit 60 set to “Low mode”, “Medium mode” or “High mode”, the heat-pressing body 1 stops the supply of electricity to the heater unit 32 after a predetermined time has elapsed since pressing. Furthermore, the alarm sound may be generated after a predetermined time has elapsed since the button was pressed.

As shown in FIGS. 1 and 11, the lamp 65 is an LED lamp that lights up when the heater unit 32 is generating heat, and notifies the user that the heater unit 32 is generating heat.

The lamp 65 is disposed in the vicinity of the user operation unit 60 and aligned with the user operation unit 60.

As shown in FIGS. 1 and 11, the controller 70 includes a CPU (processor) as a data arithmetic/control processing device, a ROM and a RAM as storage devices, and a communication interface for transmitting and receiving information data (the RAM may not be provided).

A thermal transfer process program is stored in these ROM and RAM, and the functions of the heat-pressing body 1 are realized by executing the program by the CPU (processor).

Specifically, the controller 70 is configured to perform a thermal transfer process at a preset heating temperature and for a preset heating time by receiving a signal from the user operation unit 60 and transmitting a control signal to the heater unit 32. Furthermore, the contents of various setting items may be displayed on a display screen by transmitting a control signal to a user display unit (not shown).

In the above-described configuration, the heat-pressing body 1 is connected to an external power source via the power cord 80, and the AC power supplied from the power source is rectified by a rectifier circuit and then supplied to each component such as the heater unit 32.

### <Heating Tool>

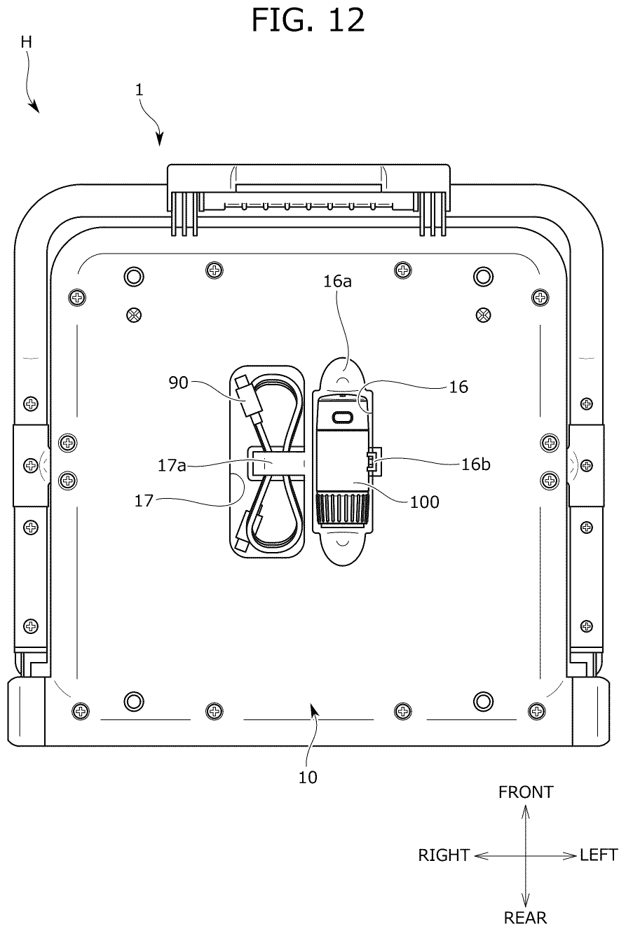

The heating tool 100 is, as shown in FIGS. 1 and 12, a tool that heats the heating object while being pressed against the surface thereof, and is used as an auxiliary tool after the heat-pressing body 1 performs a thermal transfer process.

Specifically, if minute uneven portions (bumps) appear at the corners or edges of the transfer object when the thermal transfer sheet is attached to the transfer object, the heating tool 100 can be heat-pressed against minute uneven surfaces for repair.

The heating tool 100 is a stamp type heating tool having a heating portion 160, and is also called a mini iron.

The heating tool 100 is adapted to be switched between a “normal position” in which the heating portion 160 is stored inside the heating tool and a “use position” in which the heating portion 160 is exposed to the outside.

Specifically, the heating tool 100 includes a hollow housing 110, a cap 120 which is attached to the base end of the housing 110, a grip member 130 that is fixed to the tip of the housing 110 and is held by the user, a cover 140 which is provided at the tip of the housing 110 and moves forward and backward relative to the housing 110, a biasing spring 150 which is attached inside the cover 140 and biases the cover 140, and the heating portion 160 which is exposed from the tip of the cover 140 in accordance with the forward and backward movement of the cover 140.

The cover 140 moves toward and away from the housing 110, and is switched between the “normal position” and the “use position (retracted position)” in which the cover 140 is retracted from the normal position toward the housing 110.

The biasing spring 150 is a biasing member that biases the cover 140 from the use position toward the normal position.

In the heating tool 100, the cover 140 can be retracted to the “use position (retracted position)” by pressing the tip of the cover 140 against the surface of the heating object, and the heating portion 160 can be exposed through the opening of the cover 140 so that the heating portion 160 comes into contact with the surface of the heating object. Accordingly, the heating tool 100 can heat the heating object.

In addition, the heating tool 100 includes a cable connection portion which is connected to the electric cable 90 for supplying electricity, an operation switch 180 which supplies electricity to the heating portion 160 or stops the supply of electricity, and a lamp which lights up when electricity is supplied to the heating portion 160.

As shown in FIG. 12, the bottom surface of the heat-pressing body 1 is provided with a storage recess 16 (storage portion) which stores the heating tool 100 and a removal recess 16a which is formed on the outer edge of the storage recess 16 to remove the heating tool 100.

Further, a hook portion 16b for hooking the heating tool 100 in a stored state is formed on the outer edge of the storage recess 16.

The heating tool 100 is storable in the storage recess 16 in the state of the “normal position” in which the heating portion 160 is stored inside the heating tool and is removable from the storage recess 16 in the state of the “normal position”.

Specifically, the heating tool 100 is stored in the storage recess 16 not to protrude outward from the storage recess 16.

A cable storage recess 17 for storing the electric cable 90 is formed at a position adjacent to the storage recess 16 in the bottom surface of the heat-pressing body 1.

A hook portion 17a for hooking the electric cable 90 in a stored state is formed on the outer edge of the cable storage recess 17.

In the above-described configuration, as shown in FIG. 1, the heating tool 100 is connected to the heat-pressing body 1 via the electric cable 90, and can receive electricity via the heat-pressing body 1.

Then, the heating tool 100 can heat a heating object by generating heat from the heating member 160 while being connected to the heat-pressing body 1.

Furthermore, the heating tool 100 may be provided with a separate battery. Then, the heating portion 160 can generate heat even when not connected to the heat-pressing body 1.

The above-described heat-pressing machine H can perform a thermal transfer process more appropriately than ever before. Further, a heat-pressing operation can be performed with a uniform pressure. Particularly, even when the heat-pressing machine H is made small and lightweight, a heat-pressing operation can be performed with a uniform pressure.

Specifically, it is possible to realize the heat-pressing machine H capable of performing a heat-pressing operation with a uniform pressure by swinging the pressing member 30 even when the heater surface (pressing surface) of the heater unit 32 is inclined relative to the horizontal plane in accordance with the rotating operation of the rotating member 20 (pressing member 30).

Particularly, in the conventional small heat-pressing machine, when the pressing member 30 rotates relative to the base member 10 to perform a heat-pressing operation, the heater unit 32 (heater surface) becomes easily inclined relative to the horizonal plane. As a result, a problem easily arises in which the pressing member 30 cannot uniformly press the base member 10.

Therefore, even in the configuration of the heat-pressing machine H, a heat-pressing operation can be performed with a uniform pressure even in a relatively small type.

### Others

In the above-described embodiment, as shown in FIGS. 1, 3, and 6, the placement plate 12 is adapted to be swingable relative to the base body 11, but this is not particularly limited.

For example, the placement plate 12 may be attached to the base body 11 via a movable member (for example, a movable spring or movable rubber having elasticity). Even in that case, the placement plate 12 is movable relative to the base body 11 so that the placement surface and the heater surface are aligned (as much as possible).

Alternatively, the placement plate 12 may be adapted to be rotatable to a predetermined inclination angle relative to the base body 11.

That is, the placement plate 12 may be movable relative to the base body 11 so that the placement surface of the placement plate 12 and the heater surface of the heater unit 32 are aligned (as much as possible).

In the above-described embodiment, as shown in FIGS. 1 and 4 to 6, the pressing member 30 (pressing body 31) is adapted to be swingable relative to the rotating member 20, but this is not particularly limited.

For example, the pressing member 30 may be adapted to be rotatable to a predetermined inclination angle relative to the rotating member 20. Alternatively, the pressing member 30 may be rotatably attached to the rotating member 20 and may be locked at a predetermined position.

Alternatively, the pressing member 30 may be attached to the base body 11 via a movable member (for example, a movable spring or movable rubber having elasticity).

That is, the pressing member 30 may be movable relative to the rotating member 20 so that the placement surface of the placement plate 12 and the heat surface of the heater unit 32 are aligned (as much as possible).

In the above-described embodiment, as shown in FIGS. 1 and 3 to 6, the support shaft 14 and the connecting shaft 25 extend in the extending direction of the rotating shaft 15, but this is not particularly limited.

For example, the support shaft 14 and the connecting shaft 25 may extend in a direction along intersecting the extending direction of the rotating shaft 15.

Furthermore, although it is preferable that the support shaft 14 and the connecting shaft 25 extend in the same horizontal direction, the support shaft 14 and the connecting shaft 25 may extend in different horizontal directions.

In the above-described embodiment, the heat-pressing machine according to the present invention has been mainly described. However, the above-described embodiment is merely an example for facilitating understanding of the present invention, and is not intended to limit the present invention. The present invention can be modified or improved without departing from the spirit of the invention, and the present invention naturally includes equivalents thereof.

### REFERENCE SIGNS LIST

H: heat-pressing machine
1: heat-pressing body
10: base member
11: base body
   11A: first base member
   11B: second base member
   11a: plate storage portion
   11b: shaft support portion
   11c: connection bracket
   11d: handle attachment portion
12: placement plate
   12a: plate body
   12b: outer peripheral flange
   12c: center flange
   12d: shaft support portion
13: placement mat
14: support shaft
15: rotating shaft
16: storage recess
   16a: removal recess
   16b: hook portion
17: cable storage recess
   17a: hook portion
20: rotating member
21: side frame
22: connecting frame
25: connecting shaft
   25a: restricting protrusion
30: pressing member
31: pressing body
   31a: heater storage portion
32: heater unit
33: shaft support bracket
   33a: shaft support hole
   33b: restricting recess
40: handle
41: handle body
42: hook portion
45: handle shaft
50: locking device
51: locking member
   51a: locking shaft
   51b: engagement portion
   51c: contact portion
   51d: hook portion
52: locked portion
   52a: engagement portion
   52b: movement restricting portion
53: biasing spring (biasing member)
54: operation member
55: lock cover
60: user operation unit
65: lamp
70: controller
80: power cord
90: electric cable
100: heating tool
110: housing
120: cap
130: grip member
140: cover
150: biasing spring (biasing member)
160: heating portion (heating member)
170: cable connection portion
180: operation switch

What is claimed is:

1. A heat-pressing machine for heating a thermal transfer sheet while being pressed against a transfer object, comprising:
a base member on which the transfer object is placed;
a rotating member that is attached to the base member via a rotating shaft and rotates around the rotating shaft relative to the base member; and
a pressing member that is attached to the rotating member, disposed to sandwich the transfer object and the thermal transfer sheet between the pressing member and the base member, and is adapted to rotate together with the rotating member to press the base member,
wherein the base member includes a base body which serves as a main body of the base member and a placement portion which is provided in the base body, movably attached to the base body, and adapted to place the transfer object thereon,
wherein the pressing member includes a pressing body which is movably attached to the rotating member and a heater unit which is provided in the pressing body and is able to generate heat,
wherein when the rotating member rotates relative to the base member, the pressing member presses the base member while the heater unit faces the placement portion, and
wherein the placement portion and the pressing body are movable so that a placement surface of the placement portion and a heater surface of the heater unit are aligned.

2. The heat-pressing machine according to claim 1,
wherein the rotating shaft extends in a left and right direction of the heat-pressing machine and connects a rear end of the base member to a lower end of the rotating member,
wherein the pressing member is attached to the rotating member via a connecting shaft and swings around the connecting shaft relative to the rotating member,
wherein the connecting shaft extends in an extending direction of the rotating shaft or a direction intersecting the extending direction of the rotating shaft,
wherein when the rotating member rotates relative to the base member, the pressing body swings around the connecting shaft so that the placement surface and the heater surface are aligned, and
wherein the placement portion is movable in accordance with a swinging operation of the pressing body.

3. The heat-pressing machine according to claim 2,
wherein the placement portion swings around a support shaft relative to the base body,
wherein each of the connecting shaft and the support shaft extends in the extending direction of the rotating shaft, and
wherein when the rotating member rotates relative to the base member, the placement portion and the pressing body swing so that the placement surface and the heater surface are aligned.

4. The heat-pressing machine according to claim 1, further comprising:
a locking device which locks a rotating operation of the rotating member relative to the base member,
wherein the rotating member rotates to be switched between a normal position in which the rotating member stands upward relative to the base member and a press position in which the pressing member is in contact with the base member, and
wherein the locking device is provided in a connecting portion between the base member and the rotating member and locks the rotating member at the normal position.

5. The heat-pressing machine according to claim 4,
wherein the locking device includes a locking member that is attached to one of the base member and the rotating member and switched between a locked position and an unlocked position, a locked portion which is provided in the other of the base member and the rotating member and engages with the locking member when the locking member is at the locked position, a biasing member that biases the locking member from the unlocked position toward the locked position, and an operation member that is connected to the locking member and switches the position of the locking member against a biasing force of the biasing member, and
wherein the operation member is disposed to be exposed on an outer surface of the heat-pressing machine in the left and right direction and operable toward the inside or outside of the heat-pressing machine in the left and right direction.

6. The heat-pressing machine according to claim 5,
wherein the locking member is switched between the locked position and the unlocked position by moving in the left and right direction of the heat-pressing machine,
wherein when the rotating member is located at the normal position, the locking member is movable to the locked position and is engaged with the locked portion in an up and down direction or a front and rear direction at the locked position, and
wherein when the rotating member is located at the press position, the locking member is not movable to the locked position, is located on the outside or inside of the locked portion in the left and right direction of the heat-pressing machine, and is not engaged with the locked portion.

7. The heat-pressing machine according to claim 1, further comprising:
a heat-pressing body which serves as a main body of the heat-pressing machine; and
a heating tool which is used after a thermal transfer process by the heat-pressing body and has a heating portion capable of generating heat,
wherein the heating tool is adapted to be switchable between a normal position in which the heating portion is stored inside the heating tool and a use position in which the heating portion is exposed to the outside,
wherein a storage recess capable of removably storing the heating tool is formed at a predetermined position of the heat-pressing body, and
wherein the heating tool is storable in the storage recess in the state of the normal position and is removable from the storage recess in the state of the normal position.
